(19) United States
(12) Patent Application Publication
(10) Pub. No.: US 2012/0163700 A1
(43) Pub. Date: Jun. 28, 2012

(54) IMAGE PROCESSING DEVICE AND IMAGE PROCESSING METHOD

(75) Inventor: Kiyoshi IKEDA, Kanagawa (JP)

(73) Assignee: SONY CORPORATION, Tokyo (JP)

(21) Appl. No.: 13/284,106

(22) Filed: Oct. 28, 2011

(30) Foreign Application Priority Data
Dec. 24, 2010 (JP) 2010-287836

(51) Int. Cl. G06K 9/00

(52) U.S. Cl. 382/154

(57) ABSTRACT

An image processing device which includes, a sorting circuit inputting a stereoscopic image signal formed of a left eye image and a right eye image, and outputs the left and right eye images at the same timing line by line; a parallax generation circuit generating respective parallax images from the left eye image and the right eye image which are output from the sorting circuit; each delay circuit for the left and right eye images, which delays and outputs the left and right eye images which are output from the sorting circuit by the processing time of the parallax generation circuit, respectively; and an image combining circuit which synthesizes the images which are output from the delay circuit and the parallax generation circuit, respectively, and obtains the multi-viewpoint images.

### BACKGROUND

The present disclosure relates to an image processing device and an image processing method which process an image signal with which a viewer can stereoscopically view an image with the naked eye. The present disclosure specifically relates to an image processing device and an image processing method which can further convert a sterescopic image formed of a left eye image and a right eye image to multi-viewpoint images so that it is possible to view a natural stereoscopic image not only from the front, but also from a wide viewpoint.

In the related art, it was possible to present a stereoscopic image which is seen three-dimensionally to a viewer, by displaying an image with parallax between the right and left eyes. The technology of stereoscopic images is expected to be applied to various fields such as television broadcasting, movies, remote communication, remote medicine.

For example, a time division stereoscopic image display system which is formed of a combination of a display device which alternately displays a left eye image and a right eye image with parallax, in a very short cycle, and 3D glasses with a shutter mechanism which is configured with respective liquid crystal lenses for the left eye portion and the right eye portion has already come into use (for example, refer to Japanese Unexamined Patent Application Publication No. 2010-21731). However, there are inconveniences, for example, 3D glasses are necessary in numbers equal to the viewers who are viewing simultaneously, a viewer who usually wears glasses should additionally wear 3D glasses, viewers are prone to eye fatigue when viewing images for an extended period, and the viewed image vary according to the movement of the viewpoint of the viewer. In addition, it is troublesome to carry the shutter glasses when the viewer wants to enjoy a stereoscopic image using a mobile-type information equipment, such as a mobile-type disk reproduction device.

Therefore, research and development into stereoscopic image technology in which the 3D glasses are not necessary is anticipated, in other words, which can present the stereoscopic image that can be seen with the naked eye. It is possible to make a viewer sense the image three-dimensionally with the naked eye when an image of an object which is photographed in plural directions, that is, photographed from multi-viewpoints, is obtained, each pixel of these plural images is discretely disposed, and a composite image is formed. For example, a stereoscopic image display device has been proposed in which the quality of an image of a foreground region which is projected from the display plane to the front of the viewer is prevented from deteriorating, when displaying a photographed stereoscopic image (for example, refer to Japanese Unexamined Patent Application Publication No. 2010-226500).

The stereoscopically viewable image is basically two-viewpoint images which are formed of a left eye image and a right eye image which photograph an object using a left eye camera and a right eye camera, respectively. On the contrary, it is possible to view a natural stereoscopic image not only from the front, but also from a wide viewpoint, by increasing the number of viewpoints, for example, to 4 or 8 viewpoints, and combining a parallax image which is taken in many directions.

Normally, multi-viewpoint images are formed of photographed multi-viewpoint images which are taken using a plurality of cameras (multi-viewpoint cameras) which is disposed in an array. However, since the number of multi-viewpoint cameras increases with the number of viewpoints, the production costs of content, such as shooting, increases, and the data volume of the content increases. In addition, if the data amount increases, it causes an increase in memory, increase in the scale of circuits, or the like, when viewing the stereoscopic image using the mobile-type information equipment such as the mobile-type disk reproduction device. As a result, the portability is deteriorated.

### SUMMARY

It is desirable to provide an excellent image processing device and an image processing method which can preferably process an image signal with which a viewer can see a stereoscopic image with the naked eye.

It is further desirable to provide an excellent image processing device and an image processing method which can preferably convert a stereoscopic image formed of a left eye image and a right eye image to a multi-viewpoint image so that it is possible to view a natural stereoscopic image not only from the front, but from a wide viewpoint.

According to a first embodiment of the present disclosure, there is provided an image processing device including a sorting circuit which inputs a stereoscopic image signal formed of a left eye image and a right eye image, and outputs the left and right eye images at the same timing line by line; a parallax generation circuit which generates respective parallax images from the left eye image and the right eye image which are output from the sorting circuit; each delay circuit for the left and right eye images, which delays and outputs the left and right eye images which are output from the sorting circuit by the processing time of the parallax generation circuit, respectively; and an image combining circuit which synthesizes the images which are output from the delay circuit and the parallax generation circuit, respectively, and obtains the multi-viewpoint images.

According to a second embodiment of the present disclosure, the sorting circuit of the image processing device according to a first embodiment may be configured such that the circuit inputs a 3D side-by-side type signal, includes one line of line memory which temporarily stores one line of a left eye image input by dividing one horizontal blanking interval in a time division manner, and reads one line of the left eye image from the line memory, in synchronization with the output of one line of the right eye image which is input in the latter half of the same horizontal blanking interval, and outputs.

According to a third embodiment of the present disclosure, the resolution of the 3D side-by-side type input signal is reduced to half, and respective horizontal scalers for the left and right eye images, which expands each one line signal of the left and right eye images which are output at the right time from the sorting circuit of the image processing device, in the horizonatl direction, respectively, according to the second embodiment, is further included. In addition, the parallax generation circuit may be configured to generate a parallax image signal, from signals which are expanded in the horizontal direction respectively, using each of the horizontal scalers for the left and right eye images.

According to a fourth embodiment of the present disclosure, the resolution of the 3D side-by-side type input signal is reduced to half, and each of the horizontal scalers for the left and right eye images, and for the parallax image, which horizontally expands each output signal from each delay circuit and the parallax generation circuit according to the image processing device of the second embodiment, respectively, may be further included. In addition, the image combining circuit may be configured to generate multi-viewpoint images from signals after being expanded in the horizontal direction using each of the horizontal scalers.

According to a fifth embodiment of the present disclosure, the sorting circuit of the image processing device described in the first embodiment may include four lines of line memories, mem 0, mem 1, mem 2, and mem 3. In addition, the sorting circuit is configured such that when a 3D line alternative-type signal is input, each one line of the left and right eye images which are input over two horizontal blanking intervals are temporarily stored in the line memories of mem 0 and mem 1, and each one line of the left and right eye images is output from the line memories of mem 0 and mem 1 at the same timing, in the subsequent two horizontal blanking intervals, and each one line of the left and right eye images which are input is temporarily stored in the line memories of mem 2 and mem 3.

In addition, according to a sixth embodiment of the present disclosure, there is provided an image processing method including sorting in which a stereoscopic image signal formed of a left eye image and a right eye image is input, and the left and right eye images are output line by line at the same timing; generating parallax in which respective parallax images are generated from the left eye image and the right eye image which are output in the sorting at the same timing; delaying and outputting the left and right eye images which are output in the sorting by the processing time of generating parallax, respectively; and image combining in which the images which are output from the delaying of images and the parallax generating, respectively, are synthesized, and the multi-viewpoint images are obtained.

According to the embodiments of the present disclosure, it is possible to provide an excellent image processing device and an image processing method in which a stereoscopic image formed of the left and right eye images is preferably converted to multi-viewpoint images so that a natural stereoscopic image is viewed not only from the front, but also from a wide viewpoint.

According to the embodiments of the present disclosure, it is possible to provide an excellent image processing device in which a circuit which generates multi-viewpoint images by converting photographed left and right images to multi-viewpoint images is configured by a small sized circuit and small memory capacity.

Other pursuits, characteristics, and advantages of the present disclosure will be clarified by detailed descriptions which are made based on the embodiments of the present disclosure or accompanying drawings to be described later.

### BRIEF DESCRIPTION OF THE DRAWINGS

FIG. 1 is a diagram which shows a timing chart when a 3D side-by-side type signal is input.

FIG. 2 is a diagram which shows a configuration example of multi-viewpoint conversion circuit which converts a two-viewpoint image, which is input as a 3D side-by-side type signal, to multi-viewpoint images.

FIG. 3 is a diagram which shows an internal configuration example of a sorting circuit which performs aligning of timing of a left eye image and a right eye image, when the 3D side-by-side type signal is input.

FIG. 4 is a diagram which shows another configuration example of a multi-viewpoint conversion circuit which converts a two-viewpoint image, which is input as a 3D side-by-side type signal, to multi-viewpoint images.

FIG. 5 is a diagram which shows a timing chart when a 3D line alternative-type signal is input.

FIG. 6 is a diagram which shows an internal configuration example of a sorting circuit which performs aligning of timing of a left eye image and a right eye image, when the 3D line alternative-type signal is input.

FIG. 7A is a diagram which describes a situation in which an image is converted to multi-viewpoint images, for example, from two-viewpoint images to four-viewpoint images.

FIG. 7B is a diagram which describes a situation in which an image is converted to multi-viewpoint images, for example, from two-viewpoint images to four-viewpoint images.

FIG. 8 is a diagram which shows a timing chart when a signal of 3D frame-packing type is input.

### DETAILED DESCRIPTION OF EMBODIMENTS

Hereinafter, embodiments of the present disclosure will be described in detail, with reference to drawings.

When a composite image is formed, by discretely arranging each pixel of multi-viewpoint images, it is possible to make a viewer sense images stereoscopically with the naked eye. Basic multi-viewpoint images are photographed two-viewpoint images which are formed of the left and right eye images in which an object is photographed using a left eye camera and a right eye camera, respectively. On the contrary, it is possible to view a natural stereoscopic image not only from the front, but also from a wide viewpoint, by increasing the number of viewpoints, to 4 viewpoints or 8 viewpoints, for example, and combining a parallax image which is taken in many directions.

Basically, a multi-viewpoint image is formed of photographed multi-viewpoint images which are obtained using a plurality of cameras (multi-viewpoint cameras) which is disposed in an array. On the contrary, a method of generating multi-viewpoint images from a single-viewpoint image is provided. When multi-viewpoint conversion is used, it is possible to generate multi-viewpoint images, for example, four-viewpoint images (or more) from original two-viewpoint images which are photographed using left and right eye cameras.

The multi-viewpoint conversion referred to here is processing in which depth information (parallax) is obtained from a still image which is shot using 2 viewpoints, with respect to images which are respectively shot using left and right eye cameras, and a multi-viewpoint image is generated in a pseudo manner. The processing performed here with respect to each of the left and right eye images is similar to conversion from 2D to 3D in which the depth of each object in an image is estimated and the image is converted to a pseudo stereoscopic image, with respect to a two-dimensional image.

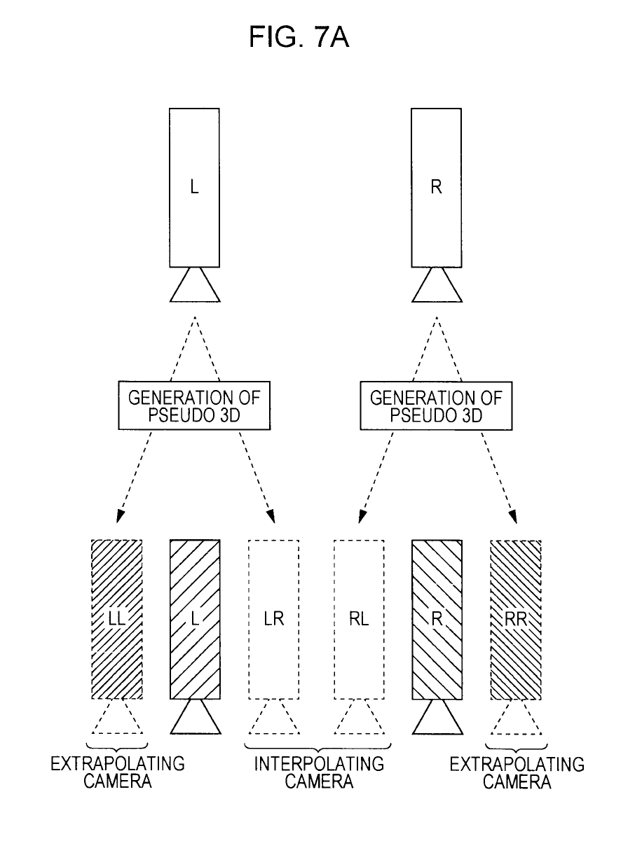

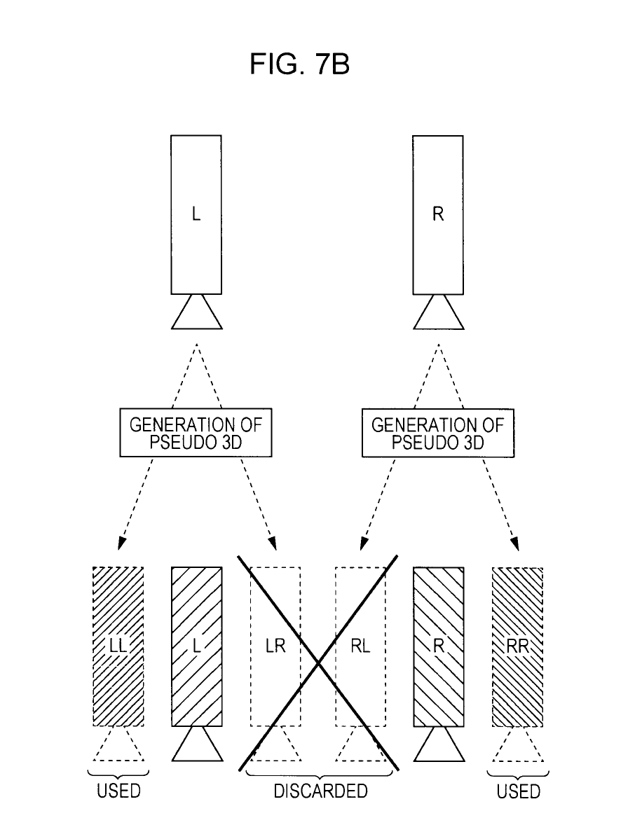

FIGS. 7A and 7B schematically show a situation in which multi-viewpoint conversion processing is performed, for example, the two-viewpoint images are converted to the four-viewpoint images, using pseudo 3D generation.

In FIG. 7A, “L” and “R” are real cameras for the left eye and right eye, respectively. It is possible to obtain a real image “L” for the left eye and a real image “R” for the right eye, respectively, from each camera.

It is possible to obtain an extrapolated image “(LL) Left-Left” which is photographed from a pseudo-camera extrapolated to the camera “L” for the left eye, and an interpolated image “(LR) Left-Right” which is photographed from a pseudo-camera interpolated into the camera “L” for the left eye, by performing pseudo 3D conversion with respect to the left eye image L which is photographed using the left eye camera. Similarly, it is possible to obtain an extrapolated image “(RR) Right-Right” which is photographed from a pseudo-camera extrapolated to the camera “R” for the right eye, and an interpolated image “(RL) Right-Left” which is photographed from a pseudo-camera interpolated into the camera “R” for the right eye, by performing pseudo 3D conversion with respect to the right eye image R which is photographed using the right eye camera. However, it is possible to set intervals of each camera LL, L, LR, RL, R, and RR to be uniform.

When each of the two-dimensional images which are photographed using two cameras on the left and right is subjected to pseudo 3D generation, it is possible to generate a 6 viewpoint image by adding two extrapolated images LL and RR, and two interpolated images. However, since the interpolated images LR and RL which are obtained from two pseudo-interpolating cameras, have a problem in that the parallax on the left and right may be reversed, the interpolated images LR and RL are not used when creating the stereoscopic image at the rear stage, and are discarded (refer to FIG. 7B). Accordingly, it is possible to generate viewpoints for 4 cameras from photographed images of two cameras. In addition, it is possible to perform multi-viewpoint conversion by discretely disposing each pixel of multi-viewpoint images, in which the extrapolated images LL and RR are added, and by forming one composite image, at the photographed two-viewpoint images L and R.

In order to generate multi-viewpoint images from a stereoscopic image signal which is formed of two-viewpoint images L and R, as described above, it is necessary to perform timing aligning of the image L for the left eye and the image R for the right eye from a signal of 3D format which is normal.

As a transmission method of a three-dimensional frame, for example, there are formats of a “frame-packing” in which one image frame for the left eye and one image frame for the right eye are interpolated in one vertical blanking interval in a time division manner, a “side-by-side (SBS)” in which left and right eye images are interpolated line by line in one horizontal blanking interval in a time division manner, a “line alternative” in which one line of the left eye image and one line of the image for right eye are alternately interpolated for each one horizontal blanking interval, or the like.

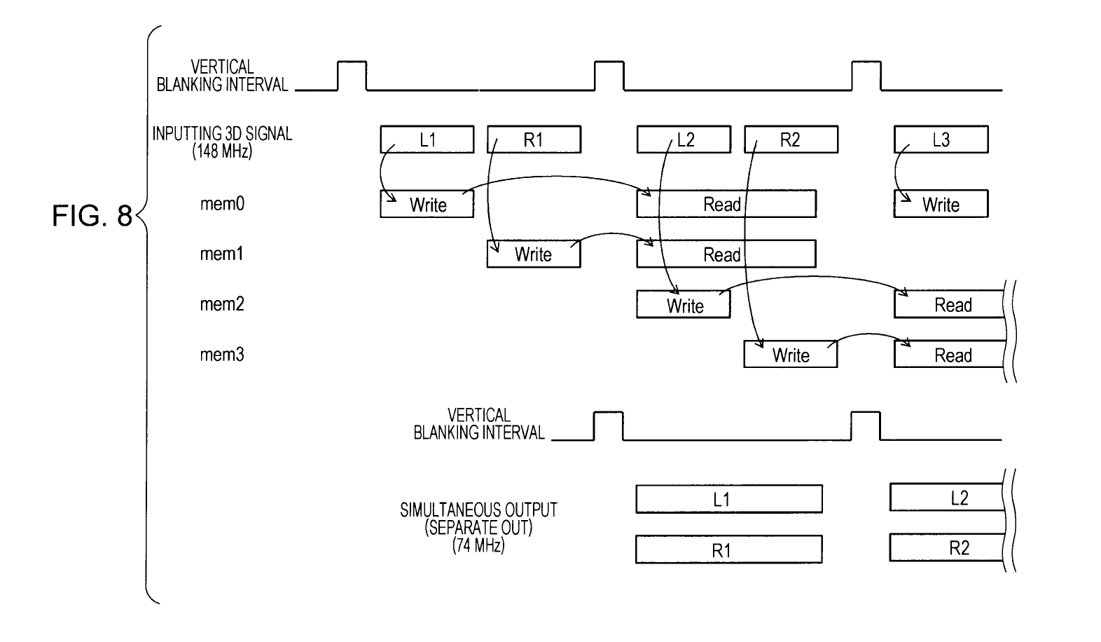

FIG. 8 shows a timing chart when a signal of 3D frame-packing type is input.

In a 148 MHz signal of the 3D frame-packing type, a full resolution left eye image frame and a full resolution right eye image frame are input in a time division manner. In addition, the image frame for the left eye and the full resolution right eye image frame are output at the same time (separated out) for each vertical blanking interval, where the frequency of the output signal is 74 MHz.

Here, a method of the timing alignment of the image L for the left eye and the image R for the right eye when the signal of 3D frame-packing type is the input signal will be considered. In one vertical blanking interval, an image frame L1 for the left eye and an image frame R1 for the right eye are input to one vertical blanking interval in a time division manner, and are temporarily stored in each of the frame memories mem 0 and mem 1. In addition, in the subsequent vertical blanking interval, an image frame L2 for the left eye and an image frame R2 for the right eye which are sequentially input are temporarily stored in each of the frame memories mem 2 and mem 3. Further, the image frame L1 for the left eye and then image frame R1 for the right eye are read at the same time from the frame memories mem 0 and mem 1 to be output to a multi-viewpoint conversion circuit. In addition, in the subsequent one vertical blanking interval, an image frame L3 for the left eye and an image frame R3 for the right eye which are sequentially input, are temporarily stored in the frame memories mem 0 and mem 1, respectively. In addition, the image frame L2 for the left eye and then image frame R2 for the right eye are read at the same time from the frame memories mem 2 and mem 3 to be output to the multi-viewpoint conversion circuit.

In order to perform multi-viewpoint conversion of two-viewpoint images, it is necessary to perform timing alignment of the image L for the left eye and the image R for the right eye, however, when the signal of 3D frame packing is input, 4 frame memories are necessary, as shown in FIG. 8.

Accordingly, the inventors propose a method in which the input signal to the multi-viewpoint conversion circuit is set to a 3D side-by-side signal, in order to reduce the memory capacity which is necessary when performing timing alignment of the image L for the left eye and the image R for the right eye. When is the signal is a side-by-side type, it is possible to perform timing alignment of the image L for the left eye and the image R for the right eye, since there are plural line memories, and it is not necessary to use a large scale memory such as a DDR (Double Date Rate). In addition, the same effect can be obtained, when the input signal is set to the 3D line alternative-type signal.

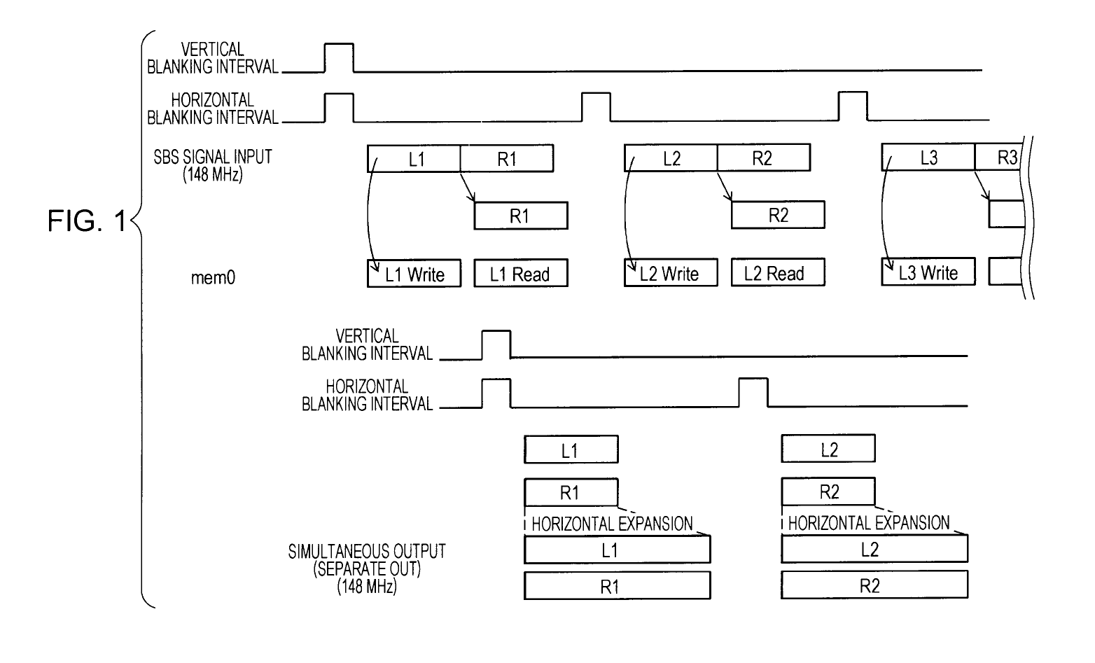

FIG. 1 shows a timing chart when the 3D side-by-side type signal is input.

In a 148 MHz 3D side-by-side type signal, each of one line of the left eye image and one line of the right eye image, of which resolution is reduced to half, is input in a time division manner for each horizontal blanking interval. In addition, each of one line of the left eye image and one line of the right eye image is horizontally expanded for each horizontal blanking interval, and is output at the same time (separate out), where the frequency of the output signal is 74 MHz.

Here, a method of performing timing alignment of the image L for the left eye and the image R for the right eye when the input signal is set to the 3D side-by-side type signal, will be considered. When the one horizontal blanking interval is divided in a time division manner, and one line L1 of the left eye image, of which the resolution is reduced to half, is input, the one line L1 is temporarily stored in the line memory mem 0. In addition, when one line R1 of the right eye image, of which the resolution is reduced to half, is input, the one line R1 of the right eye image is output as is, the one line L1 of the left eye image is read from the line memory mem 0 at the same time, and the one line R1 is output to the parallax generation circuit (to be described later) at a latter stage, in the latter half of the same horizontal blanking interval. Further, when one line L2 of the left eye image, of which the resolution is reduced to half, is input, the one line L2 is temporarily stored in the line memory mem 0, in the subsequent one horizontal blanking interval. In addition, when one line R2 of the right eye image, of which the resolution is reduced to half, is input, the one line R2 of the right eye image is output as is, the one line L2 of the left eye image is read from the line memory mem 0 at the same time, and the one line R2 is output to the parallax generation circuit (described later) at a latter stage, in the latter half of the same horizontal blanking interval. Hereinafter, the same processing is repeated.

In order to perform multi-viewpoint conversion of two-viewpoint images, it is necessary to perform timing alignment of the image L for the left eye and the image R for the right eye, however, when the 3D side-by-side type signal is input, it is possible to perform the timing alignment only with one line of line memory, as shown in FIG. 1.

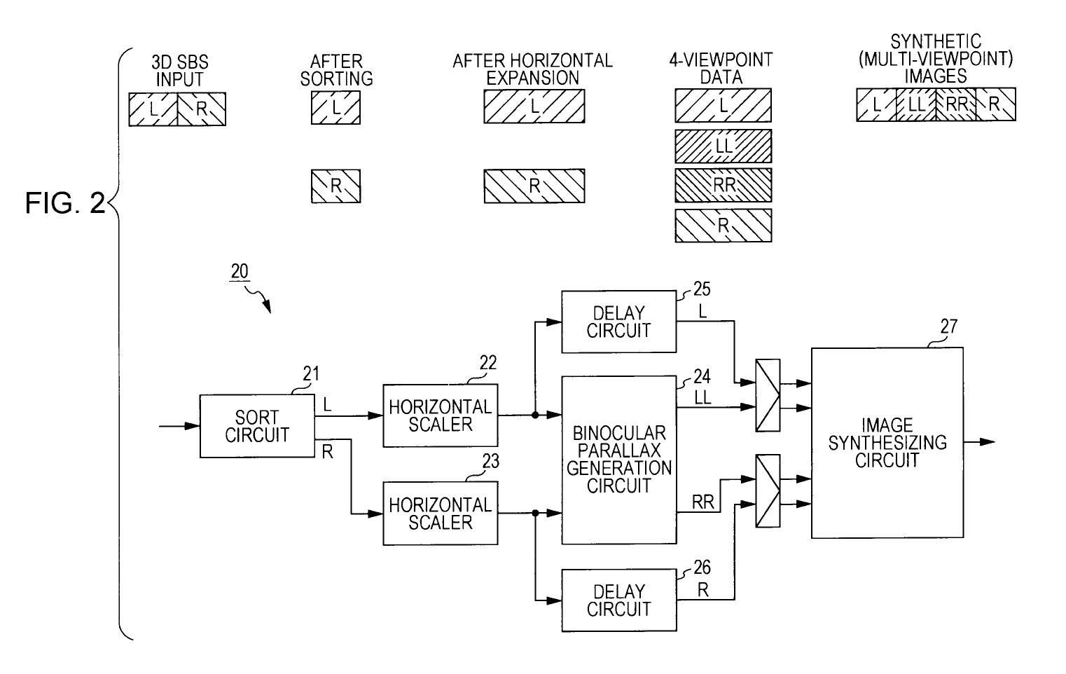

FIG. 2 shows a configuration example of a multi-viewpoint conversion circuit 20 which converts two-viewpoint images which are formed of the left eye image L and the right eye image R, to multi-viewpoint images by setting the input signal to the 3D side-by-side type signal.

A sorting circuit 21 performs timing alignment of the image L for the left eye and the image R for the right eye, when the 3D side-by-side type signal is input. That is, when one horizontal blanking interval is divided in a time division manner, and one line of the left eye image of which the resolution is reduced to half, is input, the sorting circuit 21 temporarily stores the one line image in the line memory in the sorting circuit 21. In addition, in the latter half of the same horizontal blanking interval, when one line of the right eye image, of which the resolution is reduced to half, is input, one line of the left eye image is read from the line memory, in synchronization with the output of one line of the right eye image of which the resolution is reduced to half.

The subsequent horizontal scalers 22 and 23 expands one line of the left eye image and one line of the right eye image which are output at the same time, from the sorting circuit 21 for each horizontal blanking interval, in the horizontal direction so as to be adapted to an input condition of a parallax generation circuit 24 at a latter stage.

The parallax generation circuit 24 generates one line of parallax left and right eye images which have parallax respectively with the original left and right eye images, when one line of the left eye image and one line of the right eye image which are horizontally expanded are input. Here, the parallax left eye image is an extrapolated image LL which is photographed using a pseudo extrapolating camera which is extrapolated to a left eye camera which photographs the left eye image L. In addition, the parallax right eye image is an extrapolated image RR which is photographed using a pseudo extrapolating camera which is extrapolated to a right eye camera which photographs the right eye image R.

When one line of the left eye image which is output from the horizontal scaler 22, is input, a delay circuit 25 allows a delay time during which one line of the extrapolated image LL is generated and output from the one line of the left eye image, in the parallax generation circuit 24, and outputs the one line of the image by performing the timing alignment.

In addition, when one line of the right eye image, which is output from the horizontal scaler 23, is input, a delay circuit 26 allows a delay time during which one line of the extrapolated image RR is generated and output from the one line of the right eye image, in the parallax generation circuit 24, and outputs the one line of the image by performing the timing alignment.

In this manner, it is possible to obtain four-viewpoint images of L, LL, RR, and R which are horizontally expanded. In addition, when the above described four-viewpoint images of L, LL, RR, and R are input line by line, an image combining circuit 27 forms one composite image by discretely arranging each pixel of these plural images on the basis of a predetermined rule, and outputs the composite image. In the image combining circuit 27, it is possible to appropriately arrange the pixel in consideration of the adjustment of the parallax. However, since the arrangement method of pixels of each viewpoint image is not directly related to the spirit of the present disclosure, the detailed description thereof will be omitted in the specification.

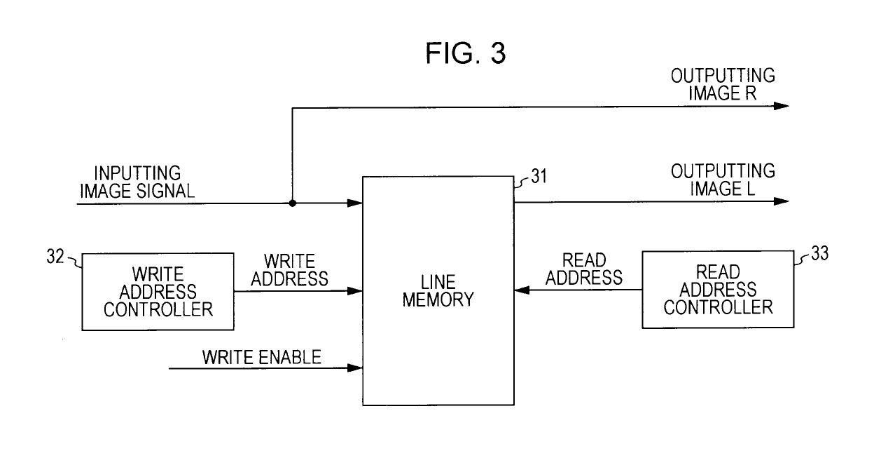

In addition, FIG. 3 shows an internal configuration example of the sorting circuit 21 which performs timing alignment of the image L for the left eye and the image R for the right eye, when the input signal is set to the 3D side-by-side type signal. When one line of the left eye image is input by dividing one horizontal blanking interval in a time division manner, the sorting circuit 21 temporarily stores the one line of the image in the line memory 31 at timing designated by a write enable signal. The write address controller 32 designates the write address of this time. In addition, when one line of the right eye image is input at a latter stage of the same horizontal blanking interval, the one line of the image is output as is, and the one line of the left eye image is read from an address which is designated in a read address controller 33 in the line memory 31.

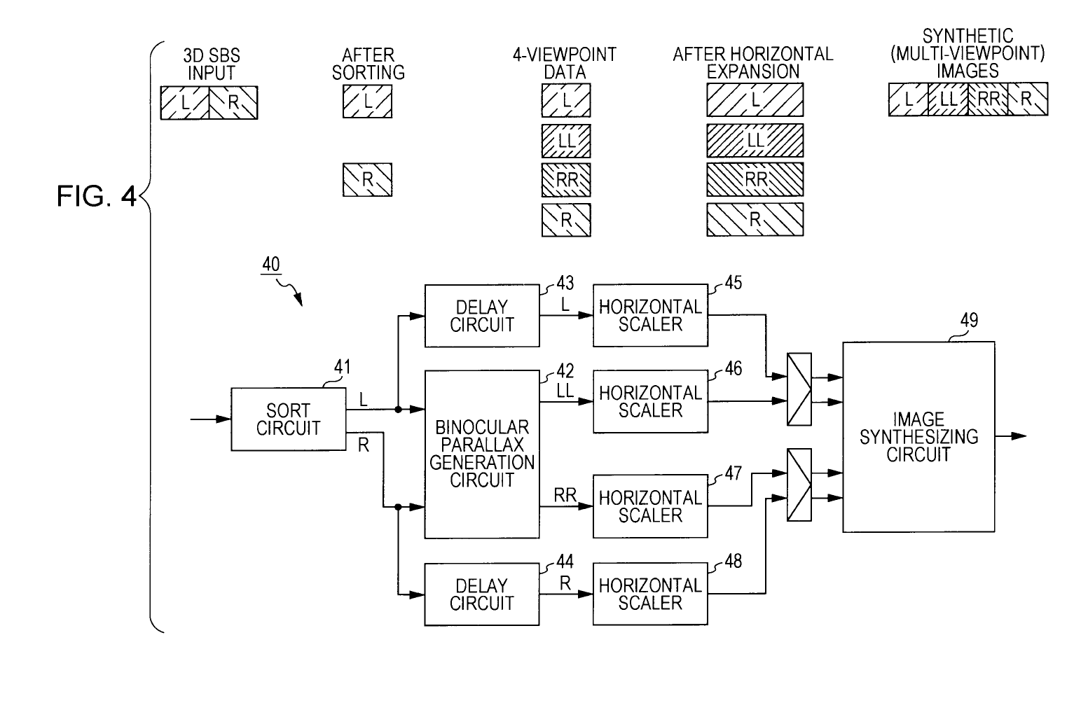

FIG. 4 shows a configuration example of the multi-viewpoint conversion circuit 20 which converts two-viewpoint images, which are formed of the left eye image L and right eye image R, to multi-viewpoint images, by setting the input signal to the 3D side-by-side type signal.

When the 3D side-by-side type signal is input, a sorting circuit 41 performs timing alignment of the left eye image L and right eye image R. That is, one horizontal blanking interval is divided in a time division manner, and one line of the left eye image, of which the resolution is reduced to half, is input, the sorting circuit 41 temporarily stores the one line of the image in a line memory in the sorting circuit 41. In addition, in the latter half of the same horizontal blanking interval, when one line of the right eye image, of which the resolution is reduced to half, is input, the one line of the left eye image is read from the line memory in synchronization with the output of one line of the right eye image of which the resolution is reduced to half. The sorting circuit 41 may have the same configuration as that shown in FIG. 3.

When one line of the left eye image and one line of the right eye image of which resolutions are still reduced to half, are input, a parallax generation circuit 42 generates one line of parallax left eye image and one line of parallax right eye image which have parallax, respectively, compared to the original left and right eye images, in a state where the resolutions are still reduced to half. Here, the parallax left eye image is an extrapolated image LL which is photographed using a pseudo extrapolating camera which is extrapolated to the left eye camera which photographs the image L for the left eye. In addition, the parallax right eye image is an extrapolated image RR which is photographed using a pseudo extrapolating camera which is extrapolated to the right eye camera which photographs the image R for the right eye.

When one line of the left eye image which is output from the sorting circuit 41 is input in the parallax generation circuit 42, a delay circuit 43 allows a delay time during which one line of the extrapolated image LL is generated and output from the one line of the left eye image, and outputs at the same timing.

When one line of the right eye image which is output from the sorting circuit 41 is input in the parallax generation circuit 42, a delay circuit 44 allows a delay time during which one line of the extrapolated image RR is generated and output from the one line of the right eye image, and outputs at the same timing.

Subsequently, each horizontal scaler 45 to 48 expands one line of each image L, LL, RR, and R which is respectively output from the delay circuit 43, the parallax generation circuit 42, and the delay circuit 44, and of which resolution is reduced to half, in the horizontal direction so as to be adapted to a horizontal size of a display device (not shown) at the output destination such as a liquid crystal panel.

In addition, when the horizontally expanded four-viewpoint images L, LL, RR, and R are input line by line, the image synthetic circuit 49 discretely arranges each pixel of these plural images on the basis of a predetermined rule, forms one composite image, and outputs. In the image synthetic circuit 49, it is possible to appropriately arrange pixels in consideration of the adjustment of the parallax. However, since the arrangement method of pixels of each viewpoint image is not directly related to the spirit of the present disclosure, a detailed description thereof will be omitted in the specification.

As shown in FIG. 2, the multi-viewpoint conversion circuit 20 performs generation processing of parallax images LL and RR, after horizontally expanding the input 3D side-by-side type signal. On the contrary, the multi-viewpoint conversion circuit 40 shown in FIG. 4 horizontally expands the four-viewpoint images L, LL, RR, and R, after generating the parallax images LL and RR from the input 3D side-by-side type signal, and these two circuits are different from each other in this point. In the former, the number of horizontal scalers is two according to the number of viewpoints of the input signal (two), however, in the latter, it becomes the number of viewpoints of the multi-viewpoint images (four) which are output signals. Accordingly, the former is able to reduce the size of the circuit. On the other hand, in the former, since the horizontal scaler performs horizontal expansion so as to be adapted to the input conditions of the parallax generation circuit, there is concern that it may not be suitable for the horizontal size of the display device at the output stage, however, in the latter, it is possible to perform the horizontal expansion so as to fit to the horizontal size of the display device, after the generation of the parallax.

Hitherto, an embodiment of a case where the 3D side-by-side type signal is used as the input signal, was described, however, it is possible to obtain the same effect of reducing the memory when the 3D line alternative-type signal is used as the input signal.

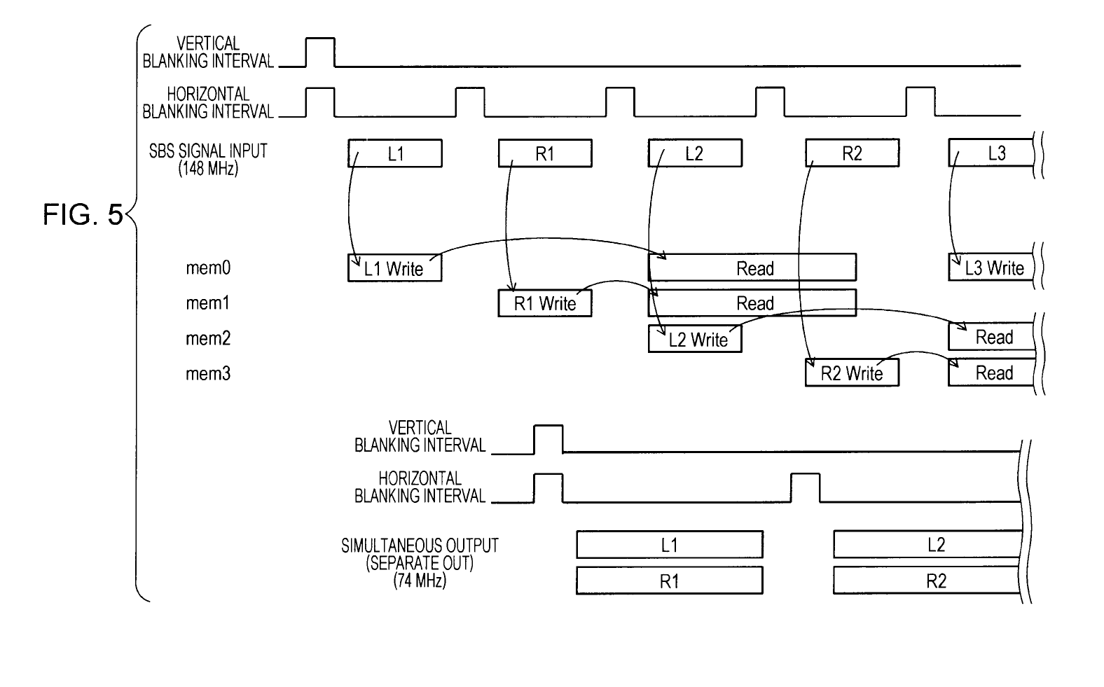

Line alternative is a signal format in which one line of the left and right eye images are alternately inserted for each one horizontal blanking interval. FIG. 5 shows a timing chart when the 3D line alternative-type signal is input.

In a 148 MHz 3D line alternative-type signal, one line of the left eye image and one line of the right eye image of full resolution are alternately input for each one horizontal blanking interval. In addition, one line of the left eye image and one line of the right eye image are simultaneously output (separate output) for each horizontal blanking interval, at an output signal frequency of 74 MHz.

Here, a method of timing alignment of the left eye image L and the right eye image R when the 3D line alternative-type signal is used as the input signal, will be considered. When one line L1 of the left eye image with full resolution, is input in the first horizontal blanking interval, the one line L1 is temporarily stored to the line memory mem 0. In addition, one line R1 of the full resolution right eye image, is input in the subsequent horizontal blanking interval, the one line R1 is temporarily stored to the line memory mem 1. In the further next horizontal blanking interval, the one line L1 of the left eye image and the one line R1 of the right eye image which are respectively stored in the line memories mem 0 and mem 1 are read, and output to the multi-viewpoint conversion circuit at the same time. In addition, the subsequent one line L2 of the left eye image, which is input in the horizontal blanking interval, is temporarily stored in the line memory mem 2. Further, the subsequent one line R2 of the right eye image, which is input in the subsequent horizontal blanking interval, is temporarily stored in the line memory mem 3. Hereinafter, the same processing is repeated.

In order to convert the two-viewpoint images to multi-viewpoint images, it is necessary to perform timing alignment of the left eye image L and the right eye image R, however, when the 3D line alternative-type signal is used as the input signal, as shown in FIG. 5, it is possible to perform timing alignment when there are four line memories.

The 3D line alternative-type signal can generate four-viewpoint images using the parallax generation circuits 20 and 40 as shown in FIG. 2 or FIG. 4, similarly to the 3D side-by-side type. However, the configuration of the sorting circuit which performs the timing alignment of the left eye image L and the right eye image R is different from each other.

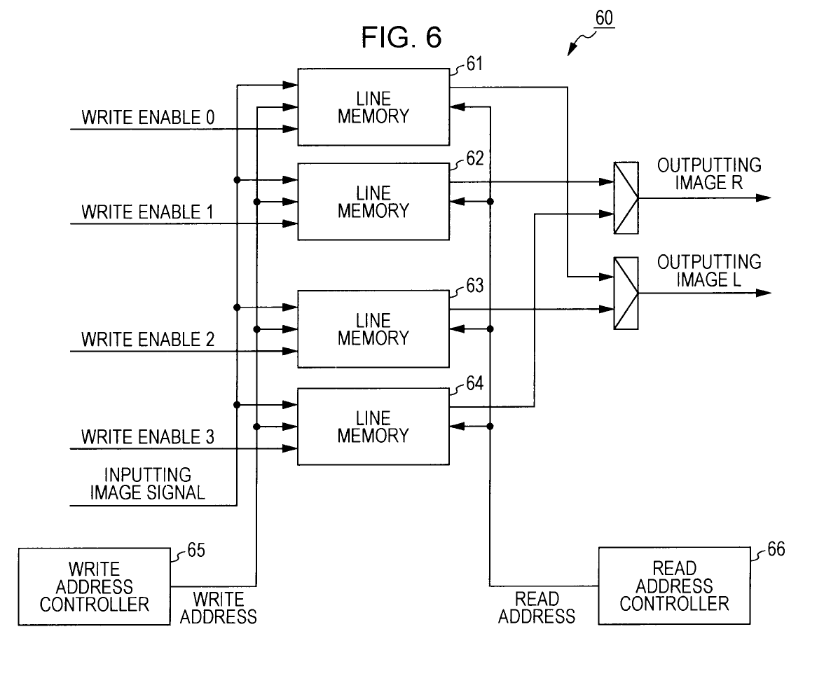

FIG. 6 shows an internal configuration example of a sorting circuit 60 which performs timing alignment of the left eye image L and the right eye image R, when the 3D line alternative-type signal is used as the input signal.

The shown sorting circuit 60 includes four line memories (mem 0, mem 1, mem 2, and mem 3) 61 to 64. A write address controller 65 designates the write address of each line memory 61 to 64. A read address controller 66 designates the read address of each line memory 61 to 64. In addition, each line memory 61 to 64 are able to write the input signal to the designated write address, respectively, using line enable signals 0 to 3.

In the first horizontal blanking interval, when one line L1 of the left eye image of a full resolution is input, the image is written to the address which is designated in the write address controller 65 in the line memory 61. In addition, in the next horizontal blanking interval, when one line R1 of the right eye image of a full resolution is input, the image is written to the address which is designated in the write address controller 65 in the line memory 62.

In the further next horizontal blanking interval, one line L1 of the left eye image and one line R1 of the right eye image are read from an address which is designated in the read address controller 66 in each of line memories 61 and 62, and output at the same time.

In addition, the subsequent one line L2 of the left eye image, which is input in the horizontal blanking interval, is written to an address which is designated in the write address controller 65 in the line memory 62. Further, the subsequent one line R2 of the right eye image which is input in the further next horizontal blanking interval, is written to an address which is designated in the write address controller 65 in a line memory 63. Hereinafter, the same processing will be repeated.

The present disclosure contains subject matter related to that disclosed in Japanese Priority Patent Application JP 2010-287836 filed in the Japan Patent Office on Dec. 24, 2010, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An image processing device comprising:
a sorting circuit which inputs a stereoscopic image signal formed of a left eye image and a right eye image, and outputs the left and right eye images at the same timing line by line;
a parallax generation circuit which generates respective parallax images from the left eye image and the right eye image which are output from the sorting circuit;
each delay circuit for the left and right eye images, which delays and outputs the left and right eye images which are output from the sorting circuit by the processing time of the parallax generation circuit, respectively; and
an image combining circuit which synthesizes the images which are output from the delay circuit and the parallax generation circuit, respectively, and obtains the multi-viewpoint images.

2. The image processing device according to claim 1,
wherein the sorting circuit inputs a 3D side-by-side type signal, includes one line of line memory which temporarily stores one line of a left eye image which is input by dividing one horizontal blanking interval in a time division manner, and reads one line of the left eye image from the line memory, in synchronization with the output of one line of the right eye image which is input in the latter half of the same horizontal blanking interval, and outputs.

3. The image processing device according to claim 2, further comprising:
respective horizontal scalers for the left and right eye images, which expands each one line signal of the left and right eye images which are output at the same timing from the sorting circuit,
wherein a resolution of the 3D side-by-side type input signal is reduced to half, and
wherein the parallax generation circuit is configured to generate a parallax image signal, from signals which are expanded in the horizontal direction respectively, using each of the horizontal scalers for the left and right eye images.

4. The image processing device according to claim 2, further comprising:
the respective horizontal scalers for the left and right eye images, and for the parallax image, which expands each output signal from each delay circuit and the parallax generation circuit, respectively, in the horizontal direction,
wherein the resolution of the 3D side-by-side type input signal is reduced to half, and,
wherein the image combining circuit is configured to generate multi-viewpoint images from a signal which is expanded in the horizontal direction respectively, using each of the horizontal scalers.

5. The image processing device according to claim 1,
wherein the sorting circuit includes line memories of four lines of mem 0, mem 1, mem 2, and mem 3; temporarily stores each one line of the left and right eye images which are input over two horizontal blanking intervals, in the line memories of mem 0 and mem 1, when a 3D line alternative-type signal is input; and outputs each one line of the left and right eye images from the line memories mem 0 and mem 1, at the same timing, and temporarily stores each one line of the left and right eye images which are input, to line memories mem 2 and mem 3, in the next two horizontal blanking intervals.

6. An image processing method comprising:
sorting in which a stereoscopic image signal formed of a left eye image and a right eye image, is input, and the left and right eye images are output line by line, at the same timing;
generating parallax in which respective parallax images are generated from the left eye image and the right eye image which are output in the sorting at the same timing;
delaying left and right eye images which are output in the sorting, by the processing time in the parallax generation, respectively, and outputs; and
image combining in which the images which are output in the delaying of images and the parallax generating, respectively, are synthesized, and the multi-viewpoint images are obtained.
